(19) United States
(12) Patent Application Publication
(10) Pub. No.: US 2011/0126386 A1
(43) Pub. Date: Jun. 2, 2011

(54) SAFETY HOOK ASSEMBLY

(76) Inventor: Feng Chia Liang, Taiping City (TW)

(21) Appl. No.: 12/629,558

(22) Filed: Dec. 2, 2009

(51) Int. Cl. F16B 45/02; A44B 13/00

(52) U.S. Cl. 24/599.5; 24/599.4; 24/599.6

(57) ABSTRACT

A safety hook assembly comprises a body including a coupling portion and a hooking portion extending from the coupling portion, between a distal end of the hooking portion and the coupling portion being defined a gap, the coupling portion including a second hole having an opening and an orifice communicating with each other; a retaining set including an engaging member, a shaft member, and a first resilient element, the shaft member being fixed to the engaging member, inserted to the second hole, and moving between the opening and the orifice; a hooking member including a safety hook and a second resilient element, the safety hook swinging to a first and a second positions of the coupling portion to actuate the shaft member to move to the orifice and the opening respectively, and the second resilient element actuating the safety hook to swing toward the first position of the coupling portion.

### BACKGROUND OF THE INVENTION

1. Field of the Invention

The present invention relates to a safety hook assembly which is capable of obtaining high force and safety purposes.

2. Description of the Prior Art

Referring to FIG. 6, a conventional safety hook assembly includes an engaging member 41 axially disposed on a body 40 by using a shaft 410 so that the engaging member 41 only swings along the shaft member 410 to close or open a gap of the body 40, and includes a safety retainer 42 to stop or release one end of the engaging member 41 so as to limit or make the engaging member 41 to swing.

However, such a conventional safety hook assembly has lower forced capability to be broken easily.

The present invention has arisen to mitigate and/or obviate the afore-described disadvantages.

### SUMMARY OF THE INVENTION

The primary object of the present invention is to provide a safety hook assembly which is capable of obtaining high force and safety purposes.

A safety hook assembly in accordance with a preferred embodiment of the present invention comprises:

a body including a coupling portion and a hooking portion extending from the coupling portion, between a distal end of the hooking portion and the coupling portion being defined a gap, the coupling portion including a second hole having an opening and an orifice communicating with each other;

a retaining set including an engaging member, a shaft member, and a first resilient element, the shaft member being fixed to the engaging member, inserted to the second hole, and moving between the opening and the orifice;

a hooking member including a safety hook and a second resilient element, the safety hook swinging to a first position and a second position of the coupling portion to actuate the shaft member to move to the orifice and the opening respectively, and the second resilient element actuating the safety hook to swing toward the first position of the coupling portion.

### BRIEF DESCRIPTION OF THE DRAWINGS

FIG. 1 is a perspective view showing the exploded components of a safety hook assembly in accordance with a preferred embodiment of the present invention;

FIG. 2 is a perspective view showing the assembly of the safety hook assembly in accordance with the preferred embodiment of the present invention;

FIG. 3 is a cross sectional showing the assembly of the safety hook assembly in accordance with the preferred embodiment of the present invention;

FIG. 4 is a cross sectional showing the operation of the safety hook assembly in accordance with the preferred embodiment of the present invention;

FIG. 5 is another cross sectional showing the operation of the safety hook assembly in accordance with the preferred embodiment of the present invention;

FIG. 6 is a perspective view of a conventional safety hook assembly.

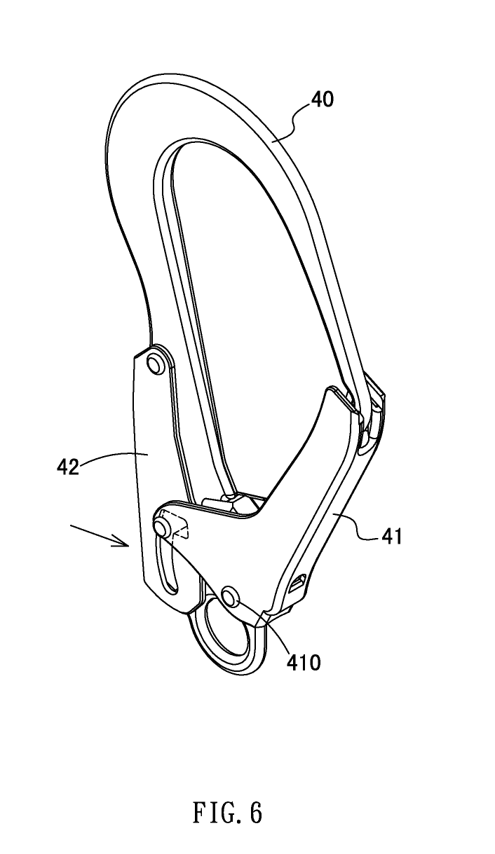

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

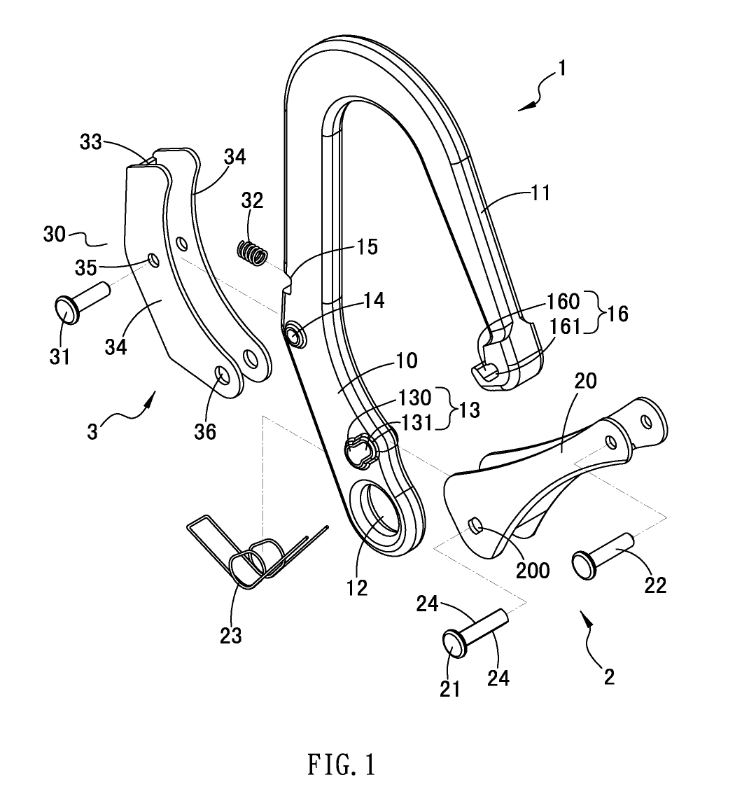

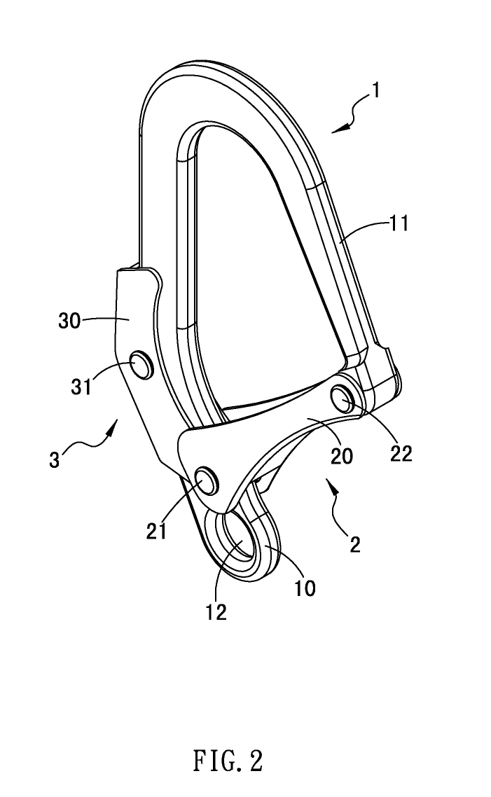

Referring to FIGS. 1-3, a safety hook assembly in accordance with a preferred embodiment of the present invention comprises a body 1, a retaining set 2, and a hooking member 3, wherein

the body 1 includes a coupling portion 10 and a hooking portion 11 extending from the coupling portion 10, the coupling portion 10 includes a first hole 12, a second hole 13, and a third hole 14, and a groove 15, the second hole 13 includes an opening 130 and an orifice 131 communicating with each other, the opening 130 is formed in a circle shape, and the orifice 131 is formed in an elongated strap shape, and a width of the orifice 131 is less than a diameter of the opening 130. The groove 15 is located at an outer side of the coupling portion 10, and the hooking portion 11 is formed in an U shape, between a distal end of the hooking portion 11 and the coupling portion 10 is defined a gap, the hooking portion 11 includes a slot 16 mounted on a distal end thereof, and the slot 16 includes a mouth section 160 and a locking section 161 connecting with each other, and the month section 160 extends to an inner side of the hooking portion 11 to form a mouth.

The retaining set 2 includes an engaging member 20, a shaft member 21, a lock bolt 22, and a first resilient element 23, wherein the engaging member 20 includes a first through bore 200 to receive the shaft member 21, and the shape of the first through bore 200 is the same as that of the shaft member 21. The shaft member 21 is fixed to one end of the lock bolt 20, inserted to the second hole 13, and moves between the opening 130 and the orifice 131. The shaft member 21 includes two parallel positioning planes 24 secured on two outer walls thereof to correspond to the orifice 131, such that the shaft member 21 moves along the orifice 131 and rotates in the opening 130. The lock bolt 22 is disposed on another end of the engaging member 20 and retained in the slot 16, and the first resilient element 23 is a torsion spring to urge the engaging member 20 to swing toward the gap between the distal end of the hooking portion 11 and the coupling portion 10 in a normal state.

The hooking member 3 includes a safety hook 30, a shank 31, and a second resilient element 32, and the safety hook 30 includes a stop member 33 and two side pieces 34 extending from two sides of the stop member 33 toward two sides of the body 1 respectively, each side piece 34 includes a second through bore 35 and an aperture 36, and the shank 31 is rotably inserted to the second through bore 35 and the third hole 14 so that the safety hook 30 swings to a first and a second positions of the coupling portion 10 along the shank 31. The aperture 36 is used to receive the shaft member 21 so that the shaft member rotates in the aperture 36, and the second resilient element 32 is a compression spring and fixed in the groove 15, and one end of the second resilient element 32 abuts against an inner side of the stop member 33 so that the safety hook 30 swings toward the first position of the coupling portion 10.

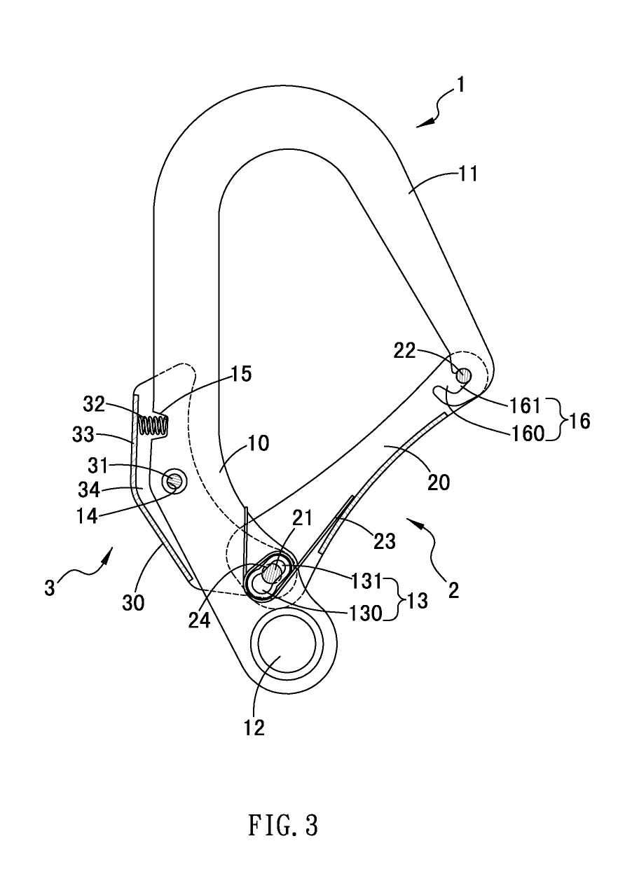

Referring to FIG. 3, the second resilient element 32 pushes the safety hook 30 to move to the first position of the coupling portion 10, and the first resilient element 23 swings the engaging member 20 toward the gap between the hooking portion 11 and the coupling portion 10, and the shaft member 21 is actuated by the safety hook 30 to move to the orifice 131 so that the positioning planes 24 of the shaft member 21 are limited by two inner side walls of the orifice 131 to stop rotation, and the lock bolt 22 is located at the locking section 161 of the slot 16, therefore the engaging member 20 is defined to stop swing by the shaft member 21 and the lock bolt 22 to prevent from opening the gap, thus obtaining a safety purpose.

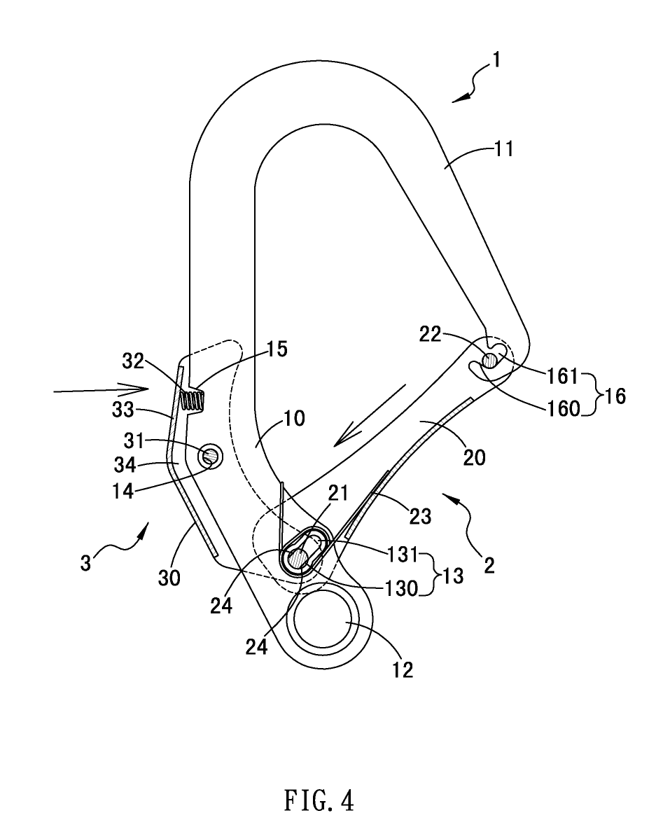

As shown in FIG. 4, when an upper end of the safety hook 30 is pressed to swing toward the second position of the coupling portion 10, the stop member 33 compresses the second resilient element 32, and the safety hook 30 actuates the shaft member 21 to move toward the opening 130 from the orifice 131, and the lock bolt 22 moves with the engaging member 20 toward the mouth section 160 from the locking section 161 of the slot 16.

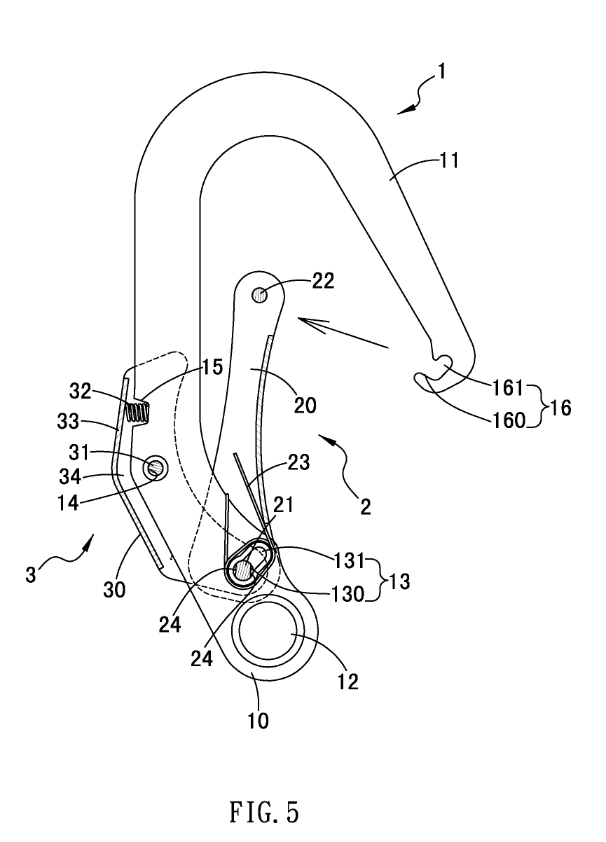

As illustrated in FIG. 5, when the shaft member 21 is located at the opening 130, the engaging member 20 swings a certain angle along the shaft member 21 so that the lock bolt 22 leaves away from the distal end of the hooking portion 11 from the mouth section 160 of the slot 16 to open the gap between the hooking portion 11 and the coupling portion 10.

Because the shaft member 21 allows to connect the engaging member 20 and the safety hook 30 together and to move in the second hole 13, when the engaging member 20 is forced by as an action, the safety hook 30 allows to decrease the action with the engaging member 20 to reinforce the engaging member 20.

While we have shown and described various embodiments in accordance with the present invention, it is clear to those skilled in the art that further embodiments may be made without departing from the scope of the present invention.

What is claimed is:

1. A safety hook assembly comprising:
a body including a coupling portion and a hooking portion extending from the coupling portion, between a distal end of the hooking portion and the coupling portion being defined a gap, the coupling portion including a second hole having an opening and an orifice communicating with each other;
a retaining set including an engaging member, a shaft member, and a first resilient element, the shaft member being fixed to the engaging member, inserted to the second hole, and moving between the opening and the orifice;
a hooking member including a safety hook and a second resilient element, the safety hook swinging to a first position and a second position of the coupling portion to actuate the shaft member to move to the orifice and the opening respectively, and the second resilient element actuating the safety hook to swing toward the first position of the coupling portion.

2. The safety hook assembly as claimed in claim 1, wherein the opening is formed in a circle shape, and the orifice is formed in an elongated strap shape, and a width of the orifice is less than a diameter of the opening, the shaft member includes two parallel positioning planes secured on two outer walls thereof to correspond to the orifice, the engaging member includes a first through bore to receive the shaft member, and the shape of the first through bore is the same as that of the shaft member, the safety hook includes an aperture to receive the shaft member so that the shaft member rotates in the aperture.

3. The safety hook assembly as claimed in claim 1, wherein the hooking portion includes a slot mounted on a distal end thereof, and the slot includes a mouth section and a locking section connecting with each other, and the month section extends to an inner side of the hooking portion to form a mouth, the engaging member includes a lock bolt disposed on another end of the engaging member and retained in the slot 16, and when the shaft member is located at the orifice, the lock bolt is located at the locking section, and when the shaft member is located at the opening, the lock bolt is located at the mouth section and allows to move outward from the mouth section.

4. The safety hook assembly as claimed in claim 3, wherein the coupling portion includes a third hole, the safety hook includes a second through bore, and the hooking member includes a shank rotably inserted to the third hole 14 and the second through bore.

5. The safety hook assembly as claimed in claim 1, wherein the second resilient element is a compression spring and fixed in a groove which is located at an outer side of the coupling portion, and the safety hook includes a stop member and two side pieces extending from two sides of the stop member toward two sides of the body respectively, and the stop member abuts against one end of the second resilient element.

6. The safety hook assembly as claimed in claim 2, wherein the second resilient element is a compression spring and fixed in a groove which is located at an outer side of the coupling portion, and the safety hook includes a stop member and two side pieces extending from two sides of the stop member toward two sides of the body respectively, and the stop member abuts against one end of the second resilient element.

7. The safety hook assembly as claimed in claim 3, wherein the second resilient element is a compression spring and fixed in a groove which is located at an outer side of the coupling portion, and the safety hook includes a stop member and two side pieces extending from two sides of the stop member toward two sides of the body respectively, and the stop member abuts against one end of the second resilient element.

8. The safety hook assembly as claimed in claim 4, wherein the second resilient element is a compression spring and fixed in a groove which is located at an outer side of the coupling portion, and the safety hook includes a stop member and two side pieces extending from two sides of the stop member toward two sides of the body respectively, and the stop member abuts against one end of the second resilient element.

9. The safety hook assembly as claimed in claim 5, wherein the coupling portion 10 includes a first hole 12.

10. The safety hook assembly as claimed in claim 6, wherein the coupling portion 10 includes a first hole 12.

11. The safety hook assembly as claimed in claim 7, wherein the coupling portion 10 includes a first hole 12.

12. The safety hook assembly as claimed in claim 8, wherein the coupling portion includes a first hole.

13. The safety hook assembly as claimed in claim 5, wherein the hooking portion is formed in an U shape.

14. The safety hook assembly as claimed in claim 6, wherein the hooking portion is formed in an U shape.

15. The safety hook assembly as claimed in claim 7, wherein the hooking portion is formed in an U shape.

16. The safety hook assembly as claimed in claim 8, wherein the hooking portion is formed in an U shape.
